(19) United States
(12) Patent Application Publication
(10) Pub. No.: US 2025/0322406 A1
(43) Pub. Date: Oct. 16, 2025

(54) ADVANCEMENT CONTINUUM DASHBOARD

(71) Applicant: Ohio State Innovation Foundation, Columbus, OH (US)

(72) Inventor: Stephanie Vaver, Columbus, OH (US)

(21) Appl. No.: 19/181,186

(22) Filed: Apr. 16, 2025

Related U.S. Application Data
(60) Provisional application No. 63/634,787, filed on Apr. 16, 2024.

(51) Int. Cl. G06Q 30/01; G06Q 10/0639; G06Q 50/20

(52) U.S. Cl. CPC G06Q 30/01; G06Q 10/06393; G06Q 50/20

(57) ABSTRACT

Systems, apparatuses, methods, and computer program products are disclosed for visualizing institutional engagement of a population. An example method includes receiving engagement data from a plurality of data sources. The example method also includes determining, in near-real-time and based on the engagement data, an engagement phase for each individual within the population. The example method also includes rendering a visual representation of engagement phase composition based on the determined engagement phase for each individual within the population.

### CROSS-REFERENCE TO RELATED APPLICATIONS

This patent application claims the benefit of U.S. Provisional Patent Application No. 63/634,787, filed Apr. 16, 2024, the entire contents of which are incorporated by reference herein.

### BACKGROUND

Certain institutions may rely on support from constituents, such as advocates and/or donors, to advance initiatives of the institution. These constituents may number in the thousands or millions and play varying roles through actions and contributions.

### BRIEF SUMMARY

In the context of a higher education institution, keeping track of constituents and their level of engagement with the institution presents a multidimensional challenge. Due to vast numbers of donors, faculty, students, alumni, and similar stakeholders, maintaining accurate records and engagement strategies introduces increasing complexity. For example, determining when and how to reach out to certain constituents requires careful consideration of certain factors, including their current level of engagement with the institution. While an institution may seek to foster meaningful connections with a diverse set of constituents, it is important to strike a balance between personalized outreach and resource efficiency (both in human and computational resources). Tracking how thousands of constituents engage with the institution is also difficult due to the constituents being spread across the country and/or world, and their interactions with the institution may vary and take place across multiple different platforms.

Conventional approaches to tracking constituents and facilitating outreach often involve inefficient, manual methods such as maintaining spreadsheets and/or paper records. These methods may rely on humans to update databases and thus introduce a risk human error (e.g., through inaccurate and/or outdated data and duplication of effort) while simultaneously consuming a significant amount time and resources. Moreover, traditional outreach methods rely on generic mailings which fail to consider current engagement levels of individual constituents. Through these conventional approaches, an institution may struggle to monitor and analyze interactions with constituents effectively, and in turn hinder their ability to gauge effectiveness of their outreach efforts and modify their strategies accordingly.

In contrast to these conventional techniques, example embodiments described herein provide a computer-implemented system and framework that provides the ability to monitor institutional engagement and automatically map (and update mappings of) individuals (i.e., constituents) to defined phases of a philanthropic journey in real-time or near-real-time based on comprehensive data collected about the individuals from a variety of remote and disparate sources. Example embodiments described herein captures and unifies engagement data from a wide range of digital sources in real-time, including, for example, signals such as electronically scrolling and/or clicking (e.g., via a mouse, trackpad, or the like) institution-related electronic communications, scanning a ticket barcode for an institution-related event, electronically registering for events, panels, and/or the like may be detected and linked to a profile for a given constituent in order for the system to determine overall engagement patterns for constituents. Further, this framework provides an interactive user interface (UI) component in an Advancement Continuum Dashboard (AC dashboard) to provide visualizations of these mappings and facilitate an assessment of strategy effectiveness in advancing constituents along the philanthropic journey. The AC dashboard is a dynamic and sophisticated tool capable of undergoing continuous updates based on newly received data to ensure accuracy and relevance.

The AC dashboard and its defined phases enable a deeper understanding and streamlining of outreach work at all levels. While it is known that, typically, constituents need to build a relationship with an institution before investing or advocating deeply, the AC dashboard makes this journey visible by providing a visual interface and a structure that allows for the ability to focus on the right audience, at the right time, for the right opportunity. For example, the AC dashboard may simultaneously visualize which part of an audience is not yet ready for a solicitation and which constituents are well-timed to move into a next phase via an ask, communication, and/or experience.

Accordingly, the present disclosure sets forth systems, methods, and apparatuses that improve constituent monitoring and outreach capabilities through an advanced, computer-implemented framework which includes an AC dashboard. There are many advantages of these and other embodiments described herein. For instance, in-depth mapping of (thousands and potentially millions of) constituent records through the framework provides a personalized map of constituents' journey, enabling outreach teams to understand their behaviors and engagement levels accurately. As discussed further herein, a detailed scoring system allows outreach teams to differentiate between individuals who are consistently engaged within a phase and those who have just entered a phase, providing valuable insights into their progression potential. Additionally, through visually presenting these mappings via the AC dashboard, outreach teams can identify bottlenecks where activities are failing to move constituents into new phases and facilitate adjustment of strategies.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a system device that may perform various operations in accordance with some example embodiments described herein.

FIG. 3A illustrates example continuum phases in accordance with some example embodiments described herein.

FIG. 3B illustrates example continuum phases and example associated actions in accordance with some example embodiments described herein.

FIG. 4 illustrates an example phase depth point criteria table in accordance with some example embodiments described herein.

FIG. 5 illustrates an example continuum timeline dashboard in accordance with some example embodiments described herein.

FIG. 6 illustrates an example global filters view in accordance with some example embodiments described herein.

FIG. 7 illustrates an example phase duration dashboard in accordance with some example embodiments described herein.

FIG. 8 illustrates an example actions taken dashboard in accordance with some example embodiments described herein.

FIG. 9 illustrates an example phase and depth overview dashboard in accordance with some example embodiments described herein.

FIG. 10 illustrates an example demographics dashboard in accordance with some example embodiments described herein.

FIG. 11 illustrates an example flowchart for real-time monitoring of institutional engagement of a population, in accordance with some example embodiments described herein.

FIG. 12 illustrates an example flowchart for real-time monitoring of institutional engagement of a population, in accordance with some example embodiments described herein.

FIG. 13 illustrates an example flowchart for real-time monitoring of institutional engagement of a population through determination of a depth score, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

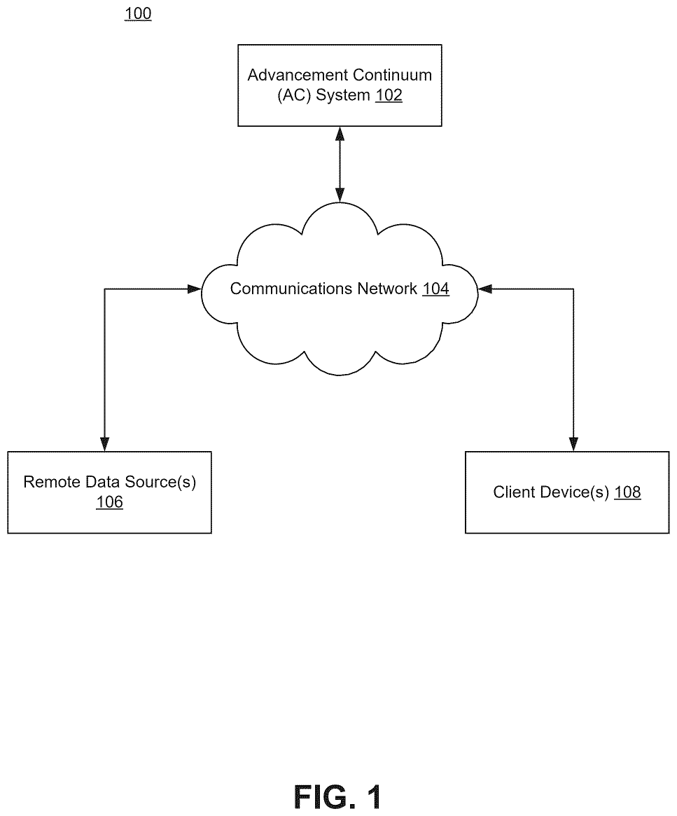

Example embodiments described herein may be implemented using any of a variety of computing devices or servers. To this end, FIG. 1 illustrates an example environment 100 within which various embodiments may operate. As illustrated, an Advancement Continuum (AC) system 102 may receive and/or transmit information via communications network 104 (e.g., the Internet) with any number of other devices, such as one or more of remote data sources 106 and/or one or more client devices 108.

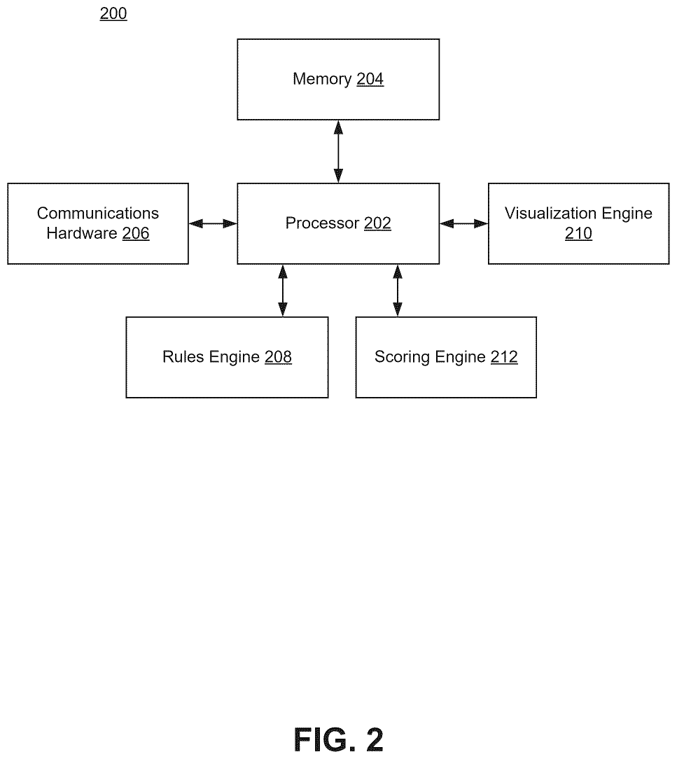

The AC system 102 may be implemented as one or more computing devices or servers, which may be composed of a series of components. Particular components of the AC system 102 are described in greater detail below with reference to apparatus 200 in connection with FIG. 2.

In some embodiments, the AC system 102 further includes a storage device that may comprise a distinct component from other components of the AC system 102. Such a storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). In some embodiments, the storage device may host the software executed to operate the AC system 102. In some embodiments, the storage device may store information relied upon during operation of the AC system 102, such as various datasets that may be used by the AC system 102, data and documents to be analyzed using the AC system 102, or the like. In addition, the storage device may store control signals, device characteristics, and access credentials enabling interaction between the AC system 102 and one or more of the remote data sources 106 or client devices 108.

The one or more remote data sources 106 and the one or more client devices 108 may be embodied by any computing devices known in the art. The one or more remote data sources 106 and the one or more client devices 108 need not themselves be independent devices, but may be peripheral devices communicatively coupled to other computing devices.

Although FIG. 1 illustrates an environment and implementation in which the AC system 102 interacts indirectly with a user via one or more remote data sources 106 and/or the one or more client devices 108, in some embodiments users may directly interact with the AC system 102 (e.g., via communications hardware of the AC system 102), in which case a separate remote data source 106 and/or client device 108 may not be utilized for direct interaction with the AC system 102. Whether by way of direct interaction or indirect interaction via another device, a user may communicate with, operate, control, modify, or otherwise interact with the AC system 102 to perform the various functions and achieve the various benefits described herein.

### Example Implementing Apparatuses

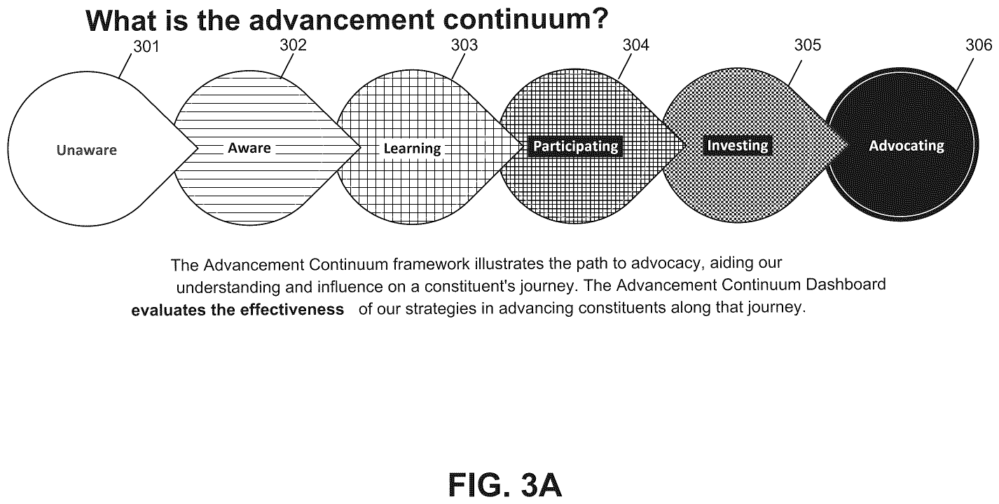

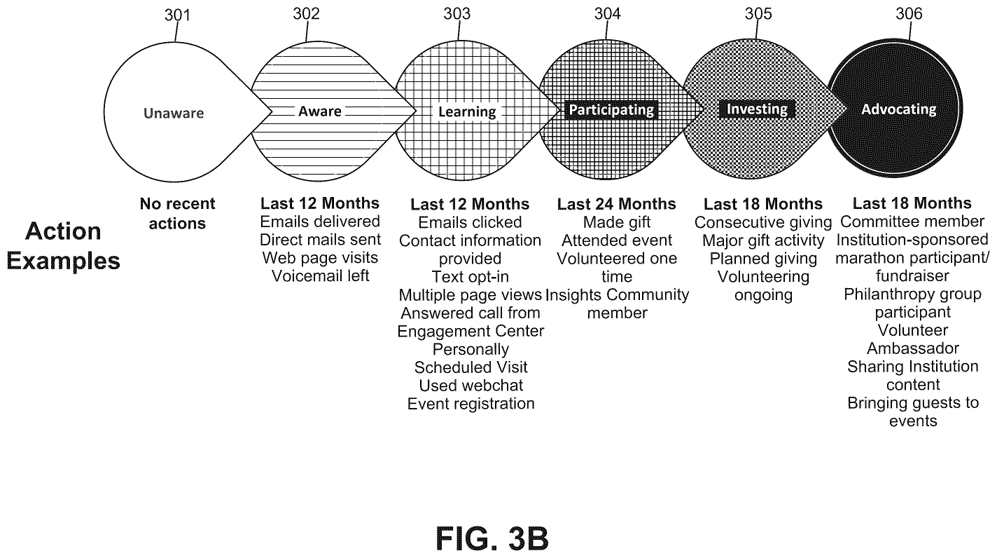

The AC system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3A-13. As illustrated in FIG. 2, the apparatus 200 may include processor 202, memory 204, communications hardware 206, rules engine 208, visualization engine 210, and scoring engine 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a rules engine 208 that maps a constituent to a phase of a continuum (as further discussed herein). The rules engine 208 may utilize processor 202, memory 204, or any other hardware component included in the apparatus 200 to perform these operations, as described in connection with FIGS. 3A-13 below. The rules engine 208 may further utilize communications hardware 206 to gather data from a variety of sources (e.g., remote data sources 106 and/or client devices 108 as shown in FIG. 1), and/or exchange data with a user, and in some embodiments may utilize processor 202 and/or memory 204 to map constituents to phases. In some examples, rules engine 208 may utilize predefined criteria and algorithms to map individuals to specific phases of engagement (using collected engagement data). In this regard, the rules engine 208 automates this mapping process to ensure consistent and accurate classification of individuals.

Further, the apparatus 200 further comprises a visualization engine 210 that renders visualizations (e.g., dashboards) based on determined mappings, collected engagement data, and/or calculated constituent scores. The visualization engine 210 may utilize processor 202, memory 204, or any other hardware component included in the apparatus 200 to perform these operations, as described in connection with FIGS. 3A-13 below. The visualization engine 210 may further utilize communications hardware 206 to gather data from a variety of sources (e.g., remote data sources 106 and/or client devices 108 as shown in FIG. 1), and/or exchange data with a user, and in some embodiments may utilize processor 202 and/or memory 204 to render one or more dashboard visualizations.

In addition, the apparatus 200 further comprises a scoring engine 212 that determines scores for individuals (e.g., depth scores). The scoring engine 212 may utilize processor 202, memory 204, or any other hardware component included in the apparatus 200 to perform these operations, as described in connection with FIGS. 3A-13 below. The scoring engine 212 may further utilize communications hardware 206 to gather data from a variety of sources (e.g., remote data sources 106 and/or client devices 108 as shown in FIG. 1), and/or exchange data with a user, and in some embodiments may utilize processor 202 and/or memory 204 to determine scores for individuals.

Although components 202-212 are described in part using functional language, it will be understood that the particular implementations necessarily include the use of particular hardware. It should also be understood that certain of these components 202-212 may include similar or common hardware. For example, the rules engine 208, visualization engine 210, and scoring engine 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the rules engine 208, visualization engine 210, and scoring engine 212 may leverage processor 202, memory 204, or communications hardware 206 as described above, it will be understood that any of rules engine 208, visualization engine 210, and scoring engine 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that rules engine 208, visualization engine 210, and scoring engine 212 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of graphical user interfaces and flowcharts.

### Example Operations

In some embodiments, through the AC system 102, constituents may be mapped to a specific phase of a philanthropic journey (also referred to herein as a “continuum”) at given times. As shown in FIG. 3A, in some examples, the AC framework consists of six phases, including an unaware phase 301, aware phase 302, learning phase 303, participating phase 304, investing phase 305, and advocating phase 306. The goal of the AC framework may be to guide a constituent to the advocating phase 306. Through the AC dashboard (described further herein), effectiveness of an institution's strategies in advancing constituents along this journey may be evaluated. In some examples, to advance phases, a constituent may need to perform one or more actions (further discussed herein) that are mapped to respective phases. Generally, based on performance (or non-performance) of actions, a score may be determined for a constituent which may be used to identify a level of engagement of a constituent within a given phase. In various embodiments, scores may be used as a basis for rendering statistical data via the AC dashboard. Additionally, in various examples, each phase may be timebound such that certain actions are required to be taken within a specific period of time. For example, if an example constituent does not consistently partake in actions of a given phase, the example constituent may fall back into a previous phase. Said differently, a constituent mapped to a current phase may be mapped to a lower phase due to not having any recorded actions within the current phase's designated time period (e.g., no action performed is recent enough).

In some examples, an example constituent mapped to the unaware phase 301 may be an individual that is not informed on opportunities to contribute to the institution. In other words, the individual may very well be aware of the institution itself, and that the institution accepts donations and holds events, but is not aware of the specifics around designation areas, needs, or types of subjects of event offerings.

In some examples, an example constituent mapped to the aware phase 302 may be an individual that has been passively exposed to opportunities to contribute to the institution but have not taken further action on these opportunities. For example, the example constituent mapped to the aware phase 302 may have performed actions such as received emails detailing the opportunities, visited a website of the institution within a predefined previous time period, and/or similar actions.

In some examples, an example constituent mapped to the learning phase 303 may be an individual that is actively seeking information about programs that align with their interests but do not directly pursue philanthropic contribution opportunities offered by the institution. For example, this example constituent may click on emails (or links provided within emails), provide contact information to the institution, opt-in to receive text message notifications from the institution, view multiple web pages associated with the institution, answer calls from the institution, and/or similar actions.

In some examples, an example constituent mapped to the participating phase 304 may be an individual that is actively taking part in opportunities that match their interests. These actions may include, for example, donating a gift, attending an event, volunteering at certain events, and/or similar actions.

In some examples, an example constituent mapped to the investing phase 305 may be an individual that demonstrates consistent engagement with respect to philanthropic opportunities associated with the institution. For example, this example constituent may consistently donate significant gifts to the institution, including planned gifts, and/or continuously volunteer on behalf of the institution.

In some examples, an example constituent mapped to the advocating phase 306 may be an individual that is not only participating in philanthropic opportunities associated with the institution, but also recruiting other individuals into these philanthropic opportunities. An example constituent mapped to the advocating phase 306 may be an institution committee member, volunteer ambassador for the institution, a member of a philanthropy group of the institution, and/or the like.

In addition to the examples above, FIG. 3B illustrates example actions that may correspond to each of phases 301-306, as well as example time periods in which actions must be performed to enter or remain within a given phase. For example, a time period of 12 months may correspond to aware phase 302 and learning phase 303, a time period of 24 months may correspond to participating phase 304, and a time period of 18 months may correspond to investing phase 305 and advocating phase 306.

In some examples, movement within the continuum, e.g., movement from phase to phase (or depth within a phase as further discussed herein) may not be linear. For example, an individual may advance from aware phase 302 to participating phase 304 in response to donating a gift to the institution (or performing a similar action associated with participating phase 304).

In various embodiments, an example institution, via AC system 102, may track engagement with constituents in order to gain insights into constituent interactions, preferences, and actions performed by the constituents. For example, through an email platform, the AC system 102 may monitor metrics such as open rates, click-through rates, and the like which provide indicators of recipient engagement levels. In some example embodiments, AC system 102 may comprise or otherwise utilize tracking tools embedded within websites and applications associated with the institution to collect data on constituent behavior, including, for example, page views, clicks, time spent viewing specific content, detect scrolling to ensure information was read, and/or the like. In some example embodiments, AC system 102 may utilize text messaging platforms to track responses and interactions with SMS-based campaigns. In some example embodiments, AC system 102 may collect event attendance records and participation metrics for in-person and/or virtual events held by the institution (e.g., by collecting data from one or more other systems (e.g., one or more remote data sources 106) associated with the institution. By collecting and aggregating this electronic engagement data of various constituents, the AC system 102 can score constituents based on their particular level of engagement with respect to performing actions associated with certain phases.

In some examples, the phase to which a constituent is currently mapped may be based on one or more actions performed by the constituent (as captured in engagement data). In some example embodiments, the highest phase with at least one action performed by the constituent may be assigned as the phase to which the constituent is mapped.

In some examples, an action may be generally categorized as one of time actions, talent actions, or treasure actions. Time actions may include actions such as event attendance, interactions, email click-throughs, and memberships. Talent actions may include actions such as serving on a volunteer committee or holding a volunteer job. Treasure actions may include actions such as making or pledging a monetary gift or in-kind gift toward the institution. In some examples, actions may be further categorized based on types of actions. The categories may include, for example, committee, communications, digital, event, giving, interactions, peer-to-peer fundraising, and volunteer. In various embodiments, an action may encompass a single recorded occurrence of an action type. Each action may be associated with an action data (e.g., a date or end date of the action).

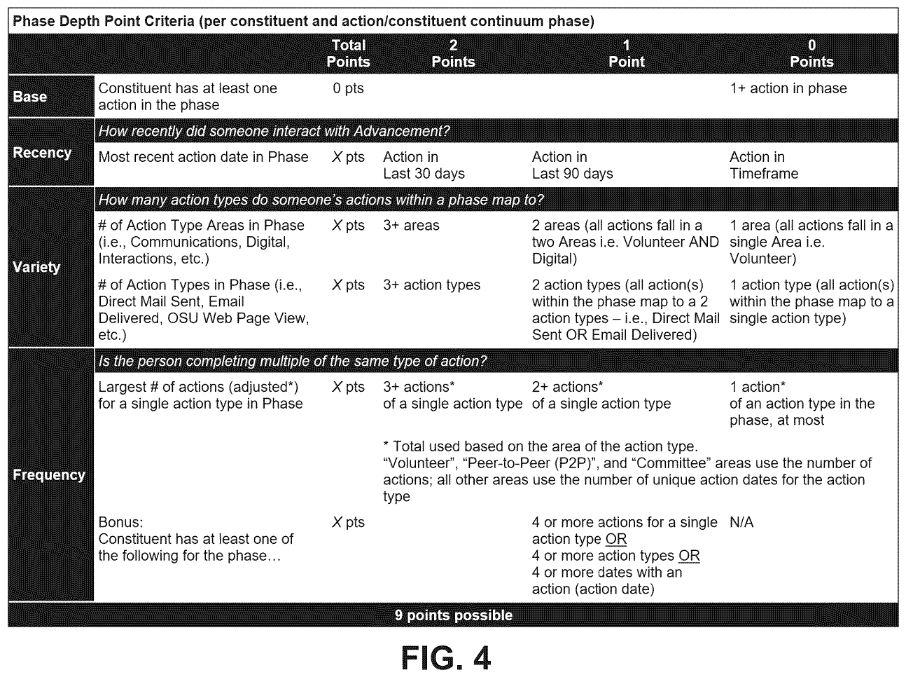

In various embodiments, each constituent tracked by the AC system 102 may be assigned a depth score, which is a value (e.g., from 0-9) that reflects the recency, frequency, and variety of actions and action types counted within a phase (e.g., one of phases 301-306 discussed above). Depth scores may help to differentiate individuals who are consistently making actions in a phase, such as attending multiple events, versus those who have just qualified for a phase, such as attending their first event. For example, while an individual may not move up to a higher phase by attending a second or third event, they are deepening their involvement in that phase, and as this depth grows, this may signify potential to move to a higher phase. In this regard, a depth score may be used to understand how much a given individual is involved. In some embodiments, a depth score is available in a field of its own, e.g., from 0-9, as well as in combination with an individual's specific phase. In some embodiments, phases may be represented numerically as numbers 1-6, with action phase represented as 1, phase represented as 2, learning phase represented as 3, phase represented as 4, phase represented as 5, and advocating phase represented as 6. For example, a depth score in combination with an individual's phase may be 3.6 (where 3 corresponds to the learning phase and 6 represents the individual's depth in the learning phase). FIG. 4 depicts an example phase depth point criteria table in accordance with some example embodiments.

Through mapping constituents into distinct phases of a continuum and assigning corresponding scores on the backend, as described above, an institution may effectively track and analyze individual engagement levels over time. This backend data may serve as a foundation for generating comprehensive data visualizations through the AC dashboard, which may include a series of dashboards that provide a user-friendly interface for accessing and interpreting statistical information. These dashboards may allow an institution to gain insights into trends, patterns, and overall effectiveness of engagement and outreach efforts, enabling the institution to make informed decisions, identify areas that need improvement, and optimize its strategies to enhance relationships with constituents and achieve institutional goals.

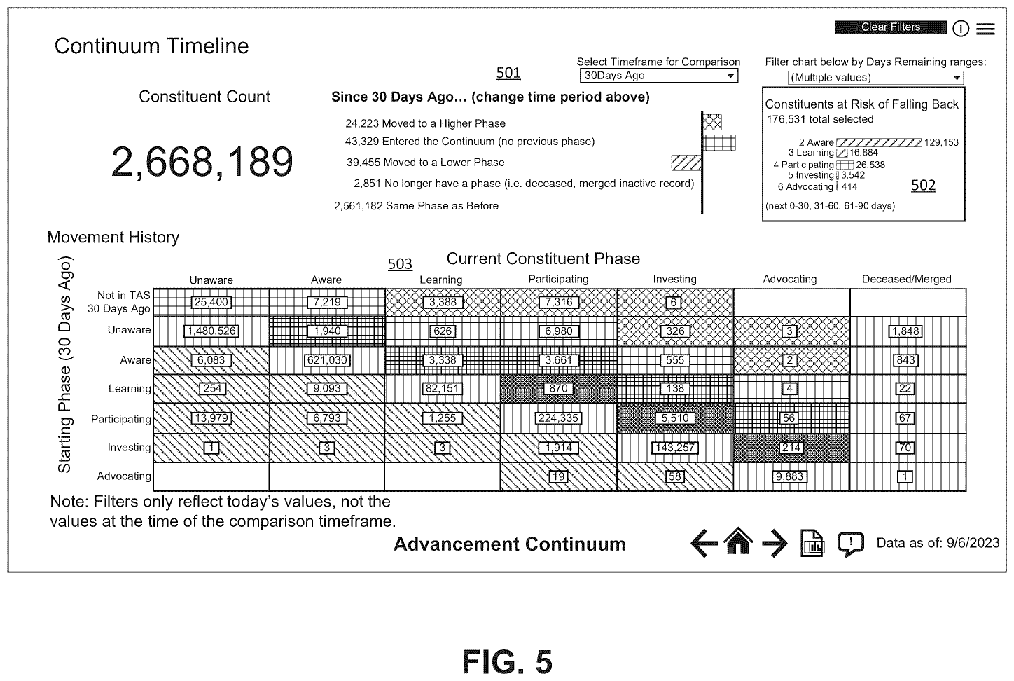

As noted above, the AC dashboard may comprise multiple dashboards. Some example dashboards and views are shown in FIGS. 5-10 and described below.

FIG. 5 depicts an example continuum timeline dashboard that includes various features. Section 501 provides a summary of the movement of constituents between phases over a selected time period. As shown, this time period is set to the previous 30 days, however, this time period may be adjusted using the dropdown menu in section 501. Section 502 provides a view of constituents who are currently in a phase and will be “falling back” out of a phase (e.g., will be mapped to a lower phase) within a selected period of time if no new actions are taken by the constituents. A user may filter, via the dropdown box shown in section 502, by days remaining (e.g., 0-90, 0-30, 31-60, and 61-90) to visualize constituents who will fall back (given no new actions are performed) within different date ranges. Section 503 provides a table that shows the movement of constituent populations over time, e.g., by comparing a set date in the past to a current date. This time period may be adjusted by selecting the dropdown menu in section 501. For example, to visualize the movement of a population by comparing what phases the population were in 30 days ago, the timeframe in the dropdown box of section 501 may be set to 30 Days Ago. As shown in the table of section 503, the starting phase represents the phase the constituents began in 30 days ago, while the current phase represents the phase the constituents are in now, after the 30-day period. For example, the intersection of ‘Unaware’ on the starting phase and the ‘Aware’ on the current phase shows that 1,940 constituents moved from unaware to aware in a 30-day period. Similarly, the intersection of ‘Unaware’ and ‘Unaware’ shows that, over a 30-day period, there was no movement for this population (e.g., 1,480,526 constituents). In various embodiments, each cell of the table shown in section 503 may be selected (e.g., clicked) by a user to filter and drill down into data.

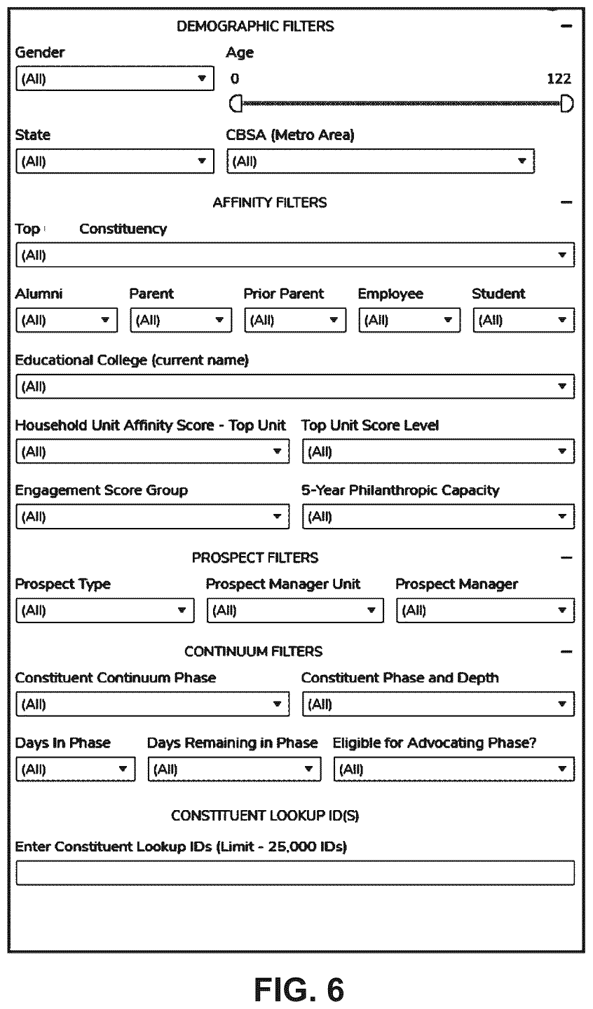

In various embodiments, the AC dashboard provides global filters which allow for the application of multiple filters and viewing of data with the applied filters in multiple dashboards. FIG. 6 shows an example global filter view. Global filters may apply to every dashboard of the AC dashboard. This global filter view may be accessed in any dashboard through a menu (e.g., the hamburger menu shown in the top-right corner of FIG. 5, for example). Global filters may be used to filter constituents by demographic information, including gender, age, state, and core-based statistical area (CBSA). Global filters also include filters for institution affinities, including Top Institution Constituency, all alumni, parents, prior parents, employees, or students, Educational College, Household Unit Affinity Score, Top Unit Score Level, Engagement Score Group and 5-Year Philanthropic Capacity.

Prospect filters include Prospect Type, Prospect Manager Unit, and Prospect Manager. Continuum filters include Constituent Continuum Phase, Constituent Phase and Depth, Days in Phase, Days Remaining in Phase, and Eligibility for Advocating Phase (Eligible for Advocating Phase may indicate that the individual has made a philanthropic gift or pledge in the last 18 months.) The global filter view may also include a field to look up constituents by a Lookup ID. In some examples, users may copy up to 25,000 ID numbers into this field.

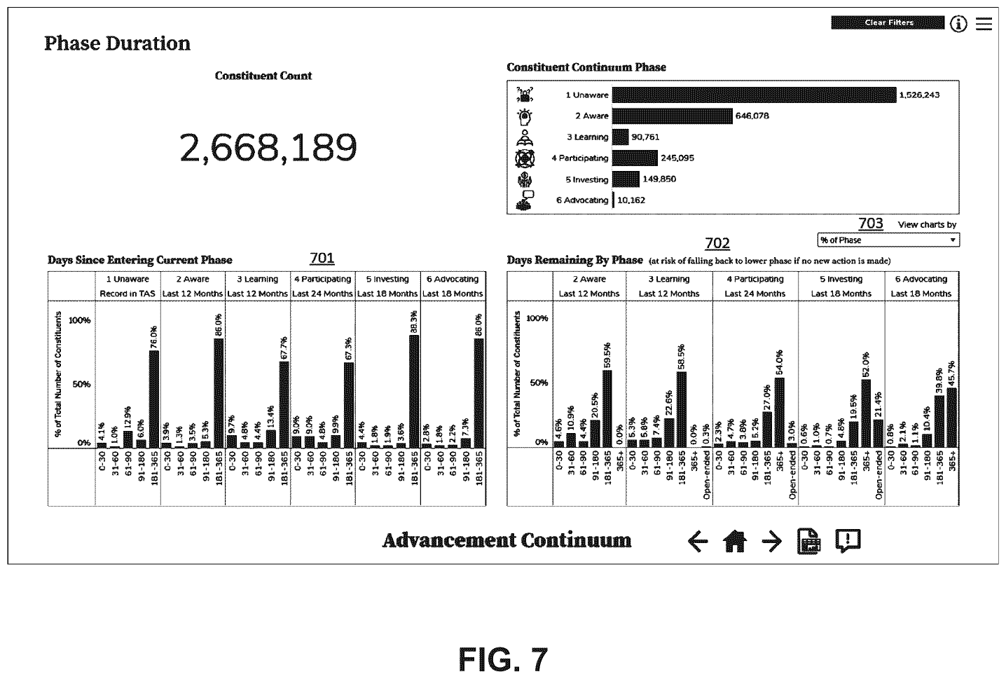

FIG. 7 depicts an example phase duration dashboard that includes various features. In various embodiments, a phase duration dashboard may show how recently a population moved into a phase or how soon until they drop out of a phase. This may be useful for outreach teams who want to plan communications around recency of entry to or exit from a phase. As mentioned above, each phase may have a set period of time or timeline in which a constituent can remain in a phase without taking action before falling back to a previous phase. Example timelines are listed for reference at the top of each chart shown in FIG. 7. Table 701 shows how many days a population has been in their current phase. Table 702 shows how many days until a population will exit their current phase unless an action is taken. A filter 703 may allow a user to view charts by percent of phase, or by number of individuals.

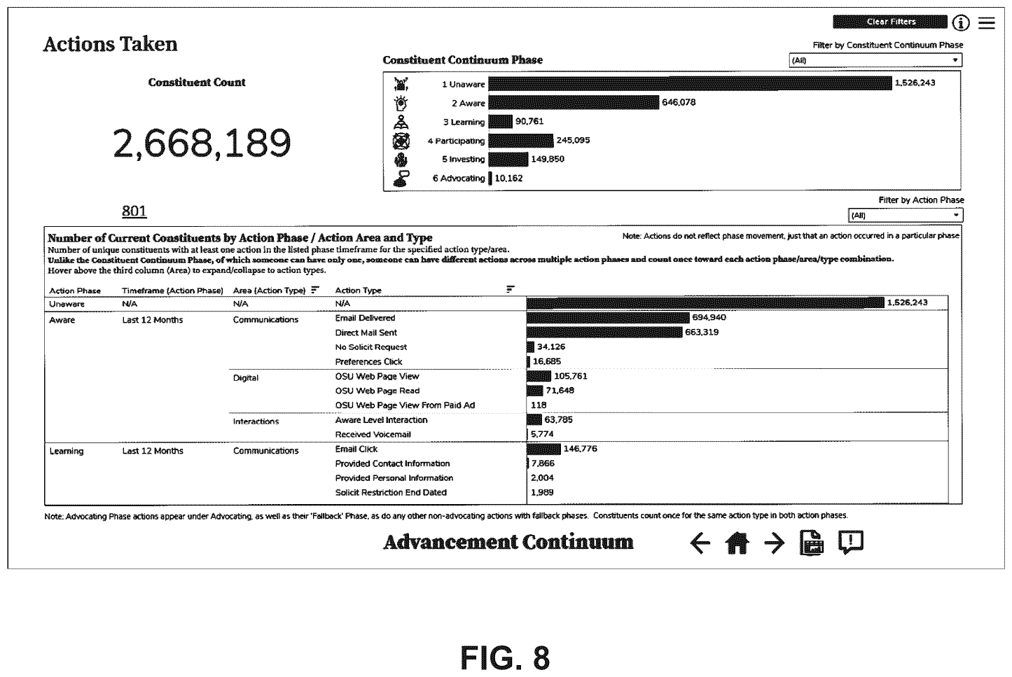

FIG. 8 depicts an example actions taken dashboard that includes various features. In various embodiments, the actions taken dashboard may show which actions are being taken, in which phases those actions are occurring in, and which populations are taking those actions. This data may be useful for individuals responsible for managing constituents in the continuum as the phase and depth score is calculated based on actions taken. Section 801 shows an example worksheet that shows which action areas and action types were taken, and also shows how many constituents completed at least one of the identified actions.

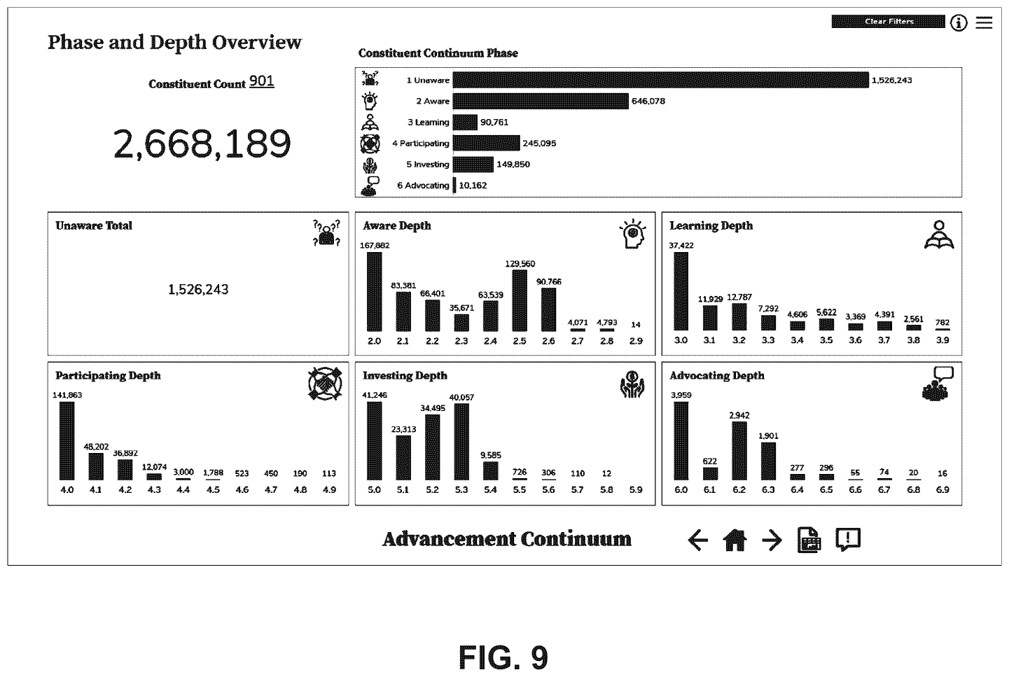

FIG. 9 shows an example phase and depth overview dashboard that includes various features. The phase and depth overview dashboard may provide a high-level view of where constituents are in the continuum as of a current date. The phase and depth overview dashboard may include a constituent count 901, which may comprise a number that reflects the total number of unique constituents who exist in the continuum when no filters are applied. As filters are applied, this number may change to reflect the total filtered populations. In some embodiments, when using an export feature of the AC system 102, the constituent count number may reflect the number of constituent identifiers (IDs) that are to be exported.

As shown in FIG. 9, the example phase and depth overview dashboard may also include six distinct worksheets that each correspond to a phase of the continuum (e.g., phases 301-306) and depict a number of constituents that correspond to a particular phase and depth score. In some examples, every constituent in the continuum may be assigned as core between 1.0 and 6.9. This score may be determined based on the frequency, recency, and variety of actions completed in action areas and action types (e.g., as shown in FIG. 4). Recency may take into account how much time has passed since actions have been taken. Frequency represents how many actions have been taken within a specified period of time. Variety refers to both action areas and action types or, how many different action areas a person has action in, and the different types of actions that have been taken. For an example score, the number before the decimal indicates an assigned phase, while the number after the decimal indicates an assigned depth within that phase. Excluding unaware phase 301 (which has no depth), a constituent can have a depth score of 1 through 9 in each phase. A graph showing the number of constituents at each depth score can be seen in each worksheet shown in FIG. 9.

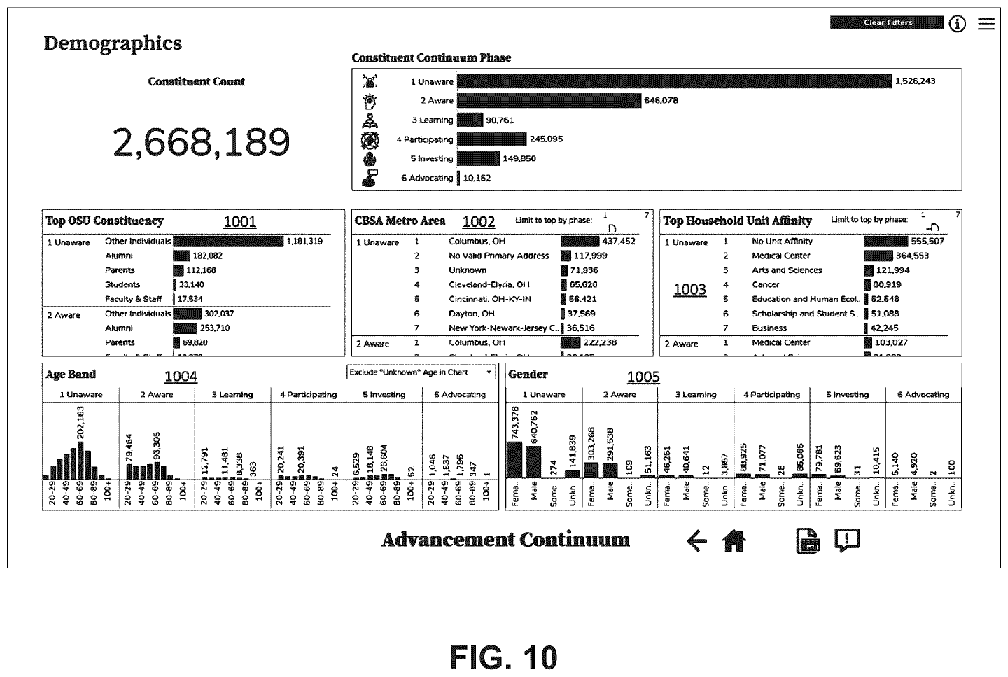

FIG. 10 shows an example demographics dashboard that includes various features. The demographics dashboard may provide various demographic overviews which may be helpful when viewing specific filtered populations. As shown in FIG. 10, the example demographics dashboard may include a top institution constituency worksheet 1001. This worksheet may show a number of individuals in each phase by top institution constituency type. In various embodiments, constituency type refers to the different relationships that constituents have with the institution. For example, Top Constituency refers to the constituency type that is the highest in the hierarchy for each individual. For example, if an individual is both alumni and staff, alumni is assigned as their top constituency type. In some examples, the hierarchical order may be (from top to bottom): alumni, parents, faculty and staff, students, and other individuals.

As shown in FIG. 10, the example demographics dashboard may include a CBSA Metro Area worksheet 1002. This worksheet may show a count of core-based statistical areas in which each constituent in the count resides. The slider at the top-right of this worksheet may be used to adjust the number of metro areas seen on the chart.

The example demographics dashboard may also include a Top Household Unit Affinity worksheet 1003. This worksheet may show the top household unit affinity for each constituent, sorted by phase. Similar to the CBSA Metro Area worksheet 1002, the slider at the top-right of this worksheet may be used to adjust how many units are displayed.

The example demographics dashboard may also include an Age Band worksheet 1004. This worksheet may show ages of constituents in each phase. The y-axis for each phase chart may show the number of instances in each age range. Additionally, a filter at the top of this worksheet may allow a user to exclude or include individuals with an unknown age.

In some examples, the example demographics dashboard may also include a Gender worksheet 1005. This worksheet may show genders of each constituent by phase.

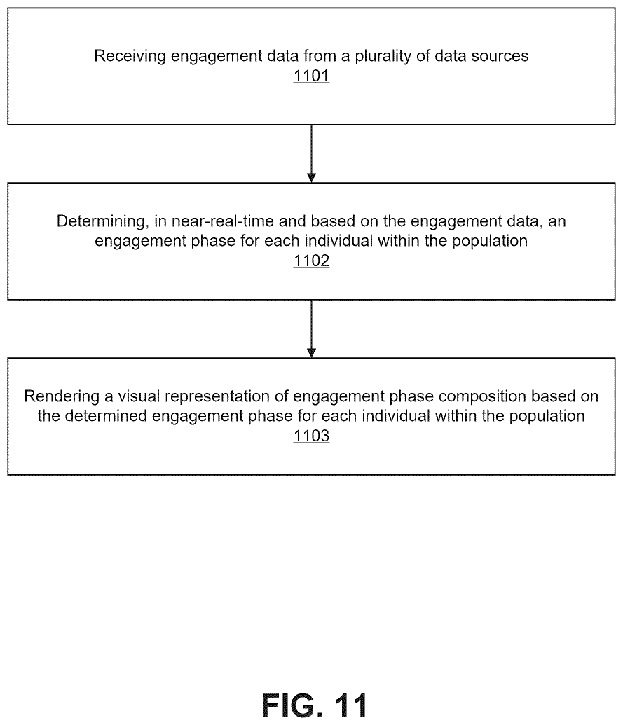

FIGS. 11-13 illustrate example flowcharts that contain example operations implemented by example embodiments described herein. The operations illustrated in FIGS. 11-13 may, for example, be performed by a system device of the AC system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, rules engine 208, visualization engine 210, scoring engine 212, and/or any combination thereof. It will be understood that user interaction with the AC system 102 may occur directly via communications hardware 206 or may instead be facilitated by a separate client device 108, as shown in FIG. 1, and which may have similar or equivalent physical componentry facilitating such user interaction.

FIG. 11 depicts example operations for visualizing institutional engagement of a population.

As shown by operation 1101, the apparatus 200 includes means, such as processor 202, memory 204, communications hardware 206, rules engine 208, visualization engine 210, scoring engine 212, and/or the like, for receiving engagement data from a plurality of data sources. In various embodiments, receiving engagement data may comprise detecting certain events taking place at one or more remote devices. As mentioned above, for example, the AC system 102 may monitor metrics associated with institution-related items, such as electronic communications (e.g., emails, text messages, etc.) such as open rates, click-through rates, and the like which provide indicators of recipient engagement levels. Additionally, in some embodiments, AC system 102 may comprise or otherwise utilize tracking tools embedded within websites and applications associated with the institution to collect data on constituent behavior, including, for example, page views, clicks, time spent viewing specific content, detected scrolling to ensure information was read, and/or the like. In some example embodiments, AC system 102 may utilize text messaging platforms to track responses and interactions with SMS-based campaigns. In some example embodiments, AC system 102 may collect event attendance records and participation metrics for in-person and/or virtual events held by the institution (e.g., by collecting data from one or more other systems (e.g., one or more remote data sources 106) associated with the institution. In some example embodiments, AC system 102 may receive feedback from one or more devices at institution-related events, such as barcode scanners or similar devices used to scan tickets associated with constituents. For example, indicia (e.g., a barcode, Quick Response (QR) code, and/or the like) of a ticket may be linked with a unique identifier that identifies a particular constituent. Upon scanning the barcode at an event, the scanning device lay log the time and location along with the unique identifier and cause transmission of this data back to AC system 102. In this regard, the apparatus 200 includes means, such as processor 202, memory 204, communications hardware 206, rules engine 208, visualization engine 210, scoring engine 212, and/or the like, for detecting a digital interaction with one or more institution-related items, wherein the digital interaction comprises at least one of (i) a scrolling interaction, (ii) a clicking interaction, or (iii) an indicia scanning interaction.

As shown by operation 1102, the apparatus 200 includes means, such as processor 202, memory 204, communications hardware 206, rules engine 208, visualization engine 210, scoring engine 212, and/or the like, for determining, in near-real-time and based on the engagement data, an engagement phase for each individual within the population. As described above, current engagement data may be received in real-time by the AC system 102, which then may determine and/or update an engagement phase for a particular individual. Continuing with the above example, attending the institution-related event may cause a depth score to be increased, which in turn may result in the constituent moving to a next phase. Alternatively, as mentioned above, in some embodiments, the highest phase with at least one action performed by the constituent may be assigned as the phase to which the constituent is mapped.

As shown by operation 1103, the apparatus 200 includes means, such as processor 202, memory 204, communications hardware 206, rules engine 208, visualization engine 210, scoring engine 212, and/or the like, for rendering a visual representation of engagement phase composition based on the determined engagement phase for each individual within the population. As described above and in connection with FIGS. 5-10, the AC dashboard may provide a dynamic interface (e.g., rendered on a client device) which simultaneously displays real-time or near-real-time analytics representing different levels of engagement across distinct population segments. The AC dashboard may be rendered via a web page, mobile application, and/or the like using one or more front-end frameworks and provide capabilities such as drill-down mechanisms, interactive filters (as described above and shown in FIG.), and options for exporting certain data in different formats for analysis (e.g., Comma Separated Values (.csv) documents, Portable Document Format (PDF) documents, etc.).

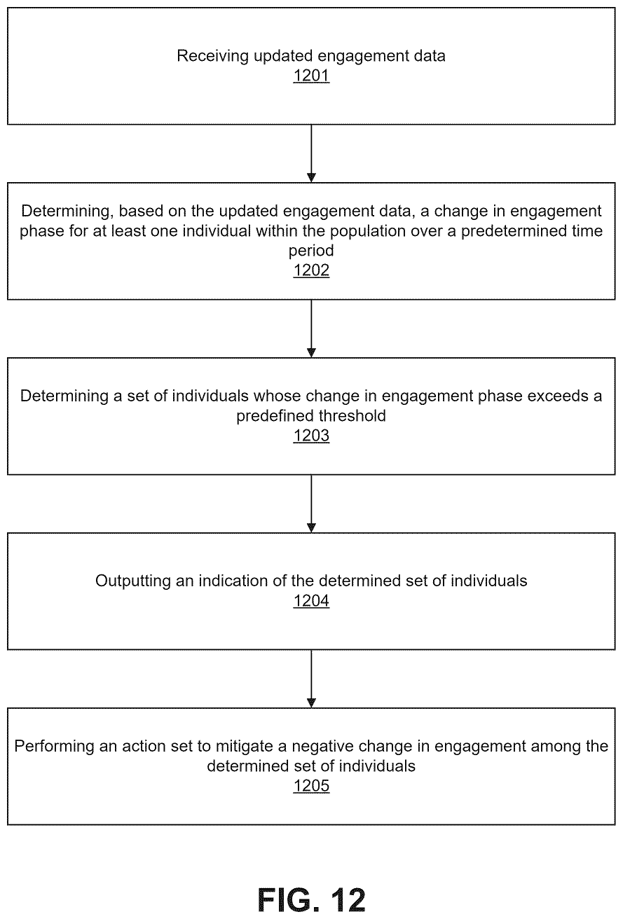

FIG. 12 depicts example operations for visualizing institutional engagement of a population.

As shown by operation 1201, the apparatus 200 includes means, such as processor 202, memory 204, communications hardware 206, rules engine 208, visualization engine 210, scoring engine 212, and/or the like, for receiving updated engagement data. In various embodiments, updated engagement data may comprise new and/or current engagement data received in real-time by AC system 102. For example, a constituent scanning an event ticket may cause updated engagement data (e.g., the unique identifier associated with the ticket, a time, and location) to be transmitted to AC system 102. As another example, a constituent viewing an email (e.g., opening the email, scrolling through the email, clicking on a link in the email, and/or the like) may cause updated engagement data relating to the email interaction to be transmitted to AC system 102.

As shown by operation 1202, the apparatus 200 includes means, such as processor 202, memory 204, communications hardware 206, rules engine 208, visualization engine 210, scoring engine 212, and/or the like, for determining, based on the updated engagement data, a change in engagement phase for at least one individual within the population over a predetermined time period. In some embodiments, this change may be determined by modifying a depth score based on the interaction indicated by the updated engagement data.

As shown by operation 1203, the apparatus 200 includes means, such as processor 202, memory 204, communications hardware 206, rules engine 208, visualization engine 210, scoring engine 212, and/or the like, for determining a set of individuals whose change in engagement phase exceeds a predefined threshold.

As shown by operation 1204, the apparatus 200 includes means, such as processor 202, memory 204, communications hardware 206, rules engine 208, visualization engine 210, scoring engine 212, and/or the like, for outputting an indication of the determined set of individuals. The indication may be conveyed via the AC dashboard in a visual format. For example, a listing of the individuals may be presented. In some embodiments, an alternative visual representation (such as a graph) may be displayed to convey the set of individuals whose change in engagement phase exceeds a predefined threshold.

As shown by operation 1205, the apparatus 200 includes means, such as processor 202, memory 204, communications hardware 206, rules engine 208, visualization engine 210, scoring engine 212, and/or the like, for performing an action set to mitigate a negative change in engagement among the determined set of individuals. For example, in some embodiments, the AC system 102 may automatically perform an action set including one or more actions based on a change in engagement (whether positive or negative). In some examples, this may include additional outreach to the constituent via electronic communications. In some embodiments, the AC system 102 may intelligently determine an optimal communication channel to perform this outreach based on past engagement data for that constituent. For example, the AC system 102 may analyze historical engagement data and determine that the constituent is mostly responsive to text messages, whereas historical email outreach to the constituent has gone unread (e.g., the constituent has not viewed and/or scrolled through historical emails, but has responded frequently to text messages). Upon determining an optimal channel, the AC system 102 (e.g., via communications hardware 206) may automatically generate and cause transmission of an electronic communication via the optimal channel.

As another example, one or more actions of an action set may include modifying a digital experience of the constituent relating to the institution. For example, upon logging in to an alumni web page or platform associated with the institution, a digital communication may be presented in the form of a pop-up window or separate element of the web page to communicate certain information to the user (e.g., thanking them for participating in a recent event, or inviting them to a next event).

As another example, one or more actions of an action set may include automatically generating unique indicia for the constituent relating to one or more upcoming events associated with the institution. For example, a QR code to purchase tickets to the event may be generated that enables early access to purchasing the tickets, preferred seating, and/or the like.

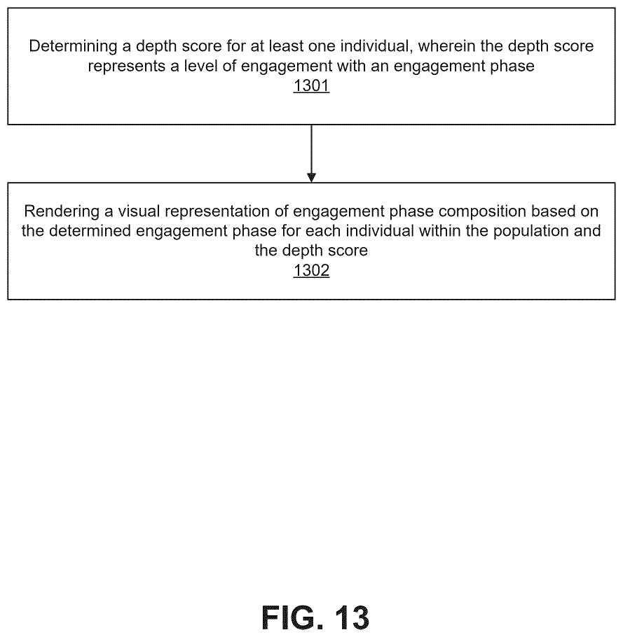

FIG. 13 depicts example operations for visualizing institutional engagement of a population through determination of a depth score.

As shown by operation 1301, the apparatus 200 includes means, such as processor 202, memory 204, communications hardware 206, rules engine 208, visualization engine 210, scoring engine 212, and/or the like, for determining a depth score for at least one individual, wherein the depth score represents a level of engagement with an engagement phase. As described above in connection with FIG. 4, a depth score may reflect the recency, frequency, and variety of actions and action types counted within a phase, and differentiate individuals who are consistently making actions in a phase, such as attending multiple events, versus those who have just qualified for a phase, such as attending their first event. In some embodiments, a depth score is available in a field of its own, e.g., from 0-9, as well as in combination with an individual's specific phase. Using the earlier example, a depth score in combination with an individual's phase may be 3.6 (where 3 corresponds to the learning phase and 6 represents the individual's depth in the learning phase).

As shown by operation 1302, the apparatus 200 includes means, such as processor 202, memory 204, communications hardware 206, rules engine 208, visualization engine 210, scoring engine 212, and/or the like, for rendering a visual representation of engagement phase composition based on the determined engagement phase for each individual within the population and the depth score.

FIGS. 11-13 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for real-time monitoring of institutional engagement of a population, the method comprising:
detecting engagement data from a plurality of data sources;
determining, in near-real-time and based on the engagement data, an engagement phase for each individual within the population; and
rendering a visual representation of engagement phase composition based on the determined engagement phase for each individual within the population.

2. The method of claim 1, wherein the engagement phase is determined from a plurality of predefined engagement phases.

3. The method of claim 1, further comprising:
receiving updated engagement data;
determining, based on the updated engagement data, a change in engagement phase for at least one individual within the population over a predetermined time period;
determining a set of individuals whose change in engagement phase exceeds a predefined threshold; and
outputting an indication of the determined set of individuals.

4. The method of claim 3, further comprising:
performing an action set to mitigate a negative change in engagement among the determined set of individuals.

5. The method of claim 1, further comprising:
determining a depth score for at least one individual, wherein the depth score represents a level of engagement within an engagement phase associated with the at least one individual,
wherein the visual representation of engagement phase composition is rendered based further on the depth score.

6. The method of claim 5, wherein the depth score is determined based on a recency value, frequency value, and one or more actions performed by the at least one individual.

7. The method of claim 1, wherein detecting the engagement data comprises:
detecting a digital interaction with one or more institution-related items, wherein the digital interaction comprises at least one of (i) a scrolling interaction, (ii) a clicking interaction, or (iii) an indicia scanning interaction.

8. A computer program product for real-time monitoring of institutional engagement of a population, the computer program product comprising at least one non-transitory computer-readable storage medium storing software instructions that, when executed, cause an apparatus to:
detect engagement data from a plurality of data sources;
determine, in near-real-time and based on the engagement data, an engagement phase for each individual within the population; and
render a visual representation of engagement phase composition based on the determined engagement phase for each individual within the population.

9. The computer program product of claim 8, wherein the engagement phase is determined from a plurality of predefined engagement phases.

10. The computer program product of claim 8, further comprising software instructions that, when executed, cause the apparatus to:
receive updated engagement data;
determine, based on the updated engagement data, a change in engagement phase for at least one individual within the population over a predetermined time period;
determine a set of individuals whose change in engagement phase exceeds a predefined threshold; and
output an indication of the determined set of individuals.

11. The computer program product of claim 10, further comprising software instructions that, when executed, cause the apparatus to:
perform an action set to mitigate a negative change in engagement among the determined set of individuals.

12. The computer program product of claim 8, further comprising software instructions that, when executed, cause the apparatus to:
determine a depth score for at least one individual, wherein the depth score represents a level of engagement within an engagement phase associated with the at least one individual,
wherein the visual representation of engagement phase composition is rendered based further on the depth score.

13. The computer program product of claim 12, wherein the depth score is determined based on a recency value, frequency value, and one or more actions performed by the at least one individual.

14. The computer program product of claim 8, wherein detecting the engagement data comprises:
detecting a digital interaction with one or more institution-related items, wherein the digital interaction comprises at least one of (i) a scrolling interaction, (ii) a clicking interaction, or (iii) an indicia scanning interaction.

15. An apparatus for real-time monitoring of institutional engagement of a population, the apparatus comprising:
means for detecting engagement data from a plurality of data sources;
means for determining, in near-real-time and based on the engagement data, an engagement phase for each individual within the population; and
means for rendering a visual representation of engagement phase composition based on the determined engagement phase for each individual within the population.

16. The apparatus of claim 15, wherein the engagement phase is determined from a plurality of predefined engagement phases.

17. The apparatus of claim 15, further comprising:
means for receiving updated engagement data;
means for determining, based on the updated engagement data, a change in engagement phase for at least one individual within the population over a predetermined time period;
means for determining a set of individuals whose change in engagement phase exceeds a predefined threshold; and
means for outputting an indication of the determined set of individuals.

18. The apparatus of claim 17, further comprising:
means for performing an action set to mitigate a negative change in engagement among the determined set of individuals.

19. The apparatus of claim 15, further comprising:
means for determining a depth score for at least one individual, wherein the depth score represents a level of engagement within an engagement phase associated with the at least one individual,
wherein the visual representation of engagement phase composition is rendered based further on the depth score.

20. The apparatus of claim 15, wherein the means for detecting the engagement data comprises:
means for detecting a digital interaction with one or more institution-related items, wherein the digital interaction comprises at least one of (i) a scrolling interaction, (ii) a clicking interaction, or (iii) an indicia scanning interaction.
